(19) United States
(12) Patent Application Publication
(10) Pub. No.: US 2026/0074341 A1
(43) Pub. Date: Mar. 12, 2026

(54) Battery for a Motor Vehicle, and Motor Vehicle

(71) Applicant: Bayerische Motoren Werke Aktiengesellschaft, Muenchen (DE)

(72) Inventors: Niko FONTEIN, Unterschleissheim (DE); Johann SCHOERGHUBER, Bruckberg (DE); Samil SERT, Muenchen (DE); Andreas WOLF, Muenchen (DE)

(21) Appl. No.: 19/101,272

(22) PCT Filed: Jul. 26, 2023
(86) PCT No.: PCT/EP2023/070749

§ 371 Date: Feb. 5, 2025

(30) Foreign Application Priority Data
Aug. 29, 2022 (DE) 10 2022 121 801.5

(51) Int. Cl. H01M 50/242; B60K 1/04; H01M 50/204; H01M 50/249; H01M 50/342

(52) U.S. Cl. CPC H01M 50/242; B60K 1/04; H01M 50/249; H01M 50/3425; B60K 2001/0438; H01M 50/204; H01M 2220/20

(57) ABSTRACT

A battery for a motor vehicle has a plurality of battery cells and a battery housing that encloses a housing interior in which the battery cells are received. The battery housing has a perforated sheet on which the battery cells are placed. The perforated sheet has, for each battery cell, an allocated degassing opening on which the allocated battery cell is placed and via which gas exiting the allocated battery cell can be guided out of the housing interior.

### BACKGROUND AND SUMMARY

The invention relates to a battery for a motor vehicle, and to a motor vehicle having a battery.

DE 10 2019 206 646 A1 discloses an energy storage housing arrangement for a motor vehicle, having an energy storage housing and an underride guard fastened to the underside of the energy storage housing. The underride guard has a sandwich arrangement with an upper cover panel on its top side facing the energy storage housing and a lower cover panel on its underside, wherein a filling means is arranged between the upper cover panel and the lower cover panel, and the upper side of the sandwich arrangement is profiled for webs or ribs.

DE 10 2011 103 993 A1 discloses a battery having a plurality of individual battery cells which are connected on at least one of their end sides to a cooling element via elastic tolerance compensation elements, wherein an electrical insulating film is arranged between the individual battery cells and the cooling element. Provision is made here for the insulating film and the tolerance compensation elements to be connected to one another integrally or in an integrally bonded manner.

Furthermore, DE 10 2019 200 465 A1 discloses a battery module arrangement which has a multiplicity of battery cells, wherein each of the multiplicity of battery cells has a cell opening formed therein and has a panel arrangement which defines a chamber, the chamber accommodating a fluid therein. Furthermore, the battery module arrangement comprises a multiplicity of openings which extend through the panel arrangement, wherein each of the multiplicity of openings is designed to be aligned with a cell opening of one of the battery cells.

Furthermore, WO 2022/031 056 A discloses a battery module and DE 10 2017 103 654 B4 discloses a battery housing for a vehicle battery.

It is the object of the invention to create a solution which permits hot gases to be particularly reliably guided away from battery cells of a battery in the event of a thermal runaway of a battery cell.

This object is achieved by the subject matter of the independent claims. Further possible refinements of the invention are disclosed in the dependent claims, the description and the figures. Features, advantages and possible refinements set forth within the scope of the description for one of the subjects of the independent claims should be considered at least analogously to be features, advantages and possible refinements of the respective subject matter of the other independent claims and of any possible combination of the subjects of the independent claims, possibly in conjunction with one or more of the dependent claims.

The invention relates to a battery for a motor vehicle, which is designed to provide electrical driving energy for an electrical drive train of the motor vehicle. This means that the motor vehicle can be driven with electrical energy from the battery. The battery can be in particular a high-voltage store of the motor vehicle. The battery has a multiplicity of battery cells and a battery housing. The battery housing surrounds a housing interior, in which the battery cells are accommodated. Furthermore, the battery housing has a perforated sheet on which the battery cells are deposited. Depositing the battery cells on the perforated sheet should be understood as meaning that the weight of the battery cells is supported by the perforated sheet. In a correct installation position of the battery in the motor vehicle, the battery cells are therefore arranged above the perforated sheet in the vertical direction of the vehicle. The battery cells can rest directly on the perforated sheet or can rest indirectly on the perforated sheet via at least one further component. A cover of the battery housing forms a sandwich construction with the perforated sheet and the battery cells arranged in between. A particularly high overall rigidity of the battery can be achieved by this sandwich construction.

The perforated sheet has, for each battery cell, an associated degassing opening on which the associated battery cell is deposited. Via this degassing opening, gas emerging from the respective associated battery cell can be conducted out of the housing interior. By the respective battery cells being deposited on the perforated sheet and, in a correct installation position, being arranged above the perforated sheet in the vertical direction of the vehicle, gases arising during a thermal runaway of a battery cell can thus be conducted away downward from the battery. This conducting away downward of the gases which arise makes it possible to keep a risk of these gases penetrating a passenger compartment of the motor vehicle particularly low. Furthermore, by the gases being conducted away downward from the respective battery cells, when the battery is arranged in a vehicle floor region of the motor vehicle, the gases can be conducted out of the motor vehicle over a particularly short route.

The thermal runaway of a battery cell and a thermal propagation, the propagation of a thermal event from battery cell to battery cell in a battery, belong to the greatest safety challenges in the operation of lithium-ion batteries as are increasingly being used in the growing electromobility sector. The provision of the perforated sheet with the degassing openings for conducting away from the battery cells hot gases which arise during the thermal runaway of a battery cell makes it possible to particularly readily prevent the thermal propagation.

Each of the battery cells can completely overlap the associated degassing opening upward in the vertical direction of the vehicle, thus making it possible to avoid gas flowing back into the housing interior via the degassing opening. Furthermore, by this means, a gas discharge opening arranged on the underside of the battery cell can be reliably arranged above the associated degassing opening.

It can thereby be ensured that a particularly large portion of gas arising during a thermal runaway of the battery cell, in particular all of the arising gas, is reliably conducted away from the battery cell via the degassing opening and therefore penetration of the gas into the housing interior is particularly reliably avoided. The respective degassing openings can align in particular with the gas discharge opening of the respectively associated battery cells.

With the invention, provision is made for a gap to be formed between the battery cells and the perforated sheet, for the battery cells in the housing interior to be encapsulated in foam and for this foam to close the gap and the degassing openings. This foam can fill the volume of the housing interior that is not filled by the battery cells or electronics, as a result of which all of the components of the battery can be reliably held in their respective positions within the housing interior. This foam additionally penetrates the gap between the respective battery cells and the associated degassing openings and closes the degassing openings of the perforated sheet. The foam can harden in these degassing openings of the perforated sheet, thus providing the sealing layer. The foam is designed to melt upon contact with hot gases emerging from the respective battery cells, as a result of which the degassing openings closed by means of the foam can be opened up for conducting the gases away from the housing interior. The foam can thus be used to secure all of the components of the battery in the housing interior and to seal the degassing openings, in particular watertightly.

Alternatively or additionally, provision is made for the impact absorption foam to be adhesively bonded onto a side of the perforated sheet opposite the battery cells. The adhesive bonding of the impact absorption foam onto the perforated sheet results in the impact absorption foam being held particularly securely on the perforated sheet. In particular when the battery is configured both with the impact absorption foam, which is adhesively bonded to the perforated sheet, and with the trough, the trough can be exchanged particularly easily since the impact absorption foam is securely held on the perforated sheet.

In one possible development of the invention, provision is made for the perforated sheet to be formed from steel or from aluminum. The perforated sheet from aluminum has a particularly low weight. The perforated sheet from steel has particularly high stability and rigidity and, as a result, a particularly long service life. It is equally possible for the perforated sheet to comprise both steel and aluminum.

In one further possible refinement of the invention, provision is made for the degassing openings to be sealed, in particular sealed watertightly, by means of a sealing layer. This sealing layer is designed to be broken through by hot gas flowing out of the battery cells in the event of a thermal runaway. The thermal runaway is understood as meaning the igniting or the explosion of a battery cell as a result of exothermic reactions in the respective battery cells. In order to avoid a chain reaction of a plurality of battery cells right through to all of the battery cells of the battery and thus to prevent the onset of a self-perpetuating reaction, the gases arising during the thermal runaway of an individual battery cell are conducted away via the associated degassing opening. In order, during normal operation of the battery, to ensure tightness of the housing interior, in particular the tightness in relation to water so as to avoid an ingress of water into the housing interior, the sealing layer is provided. This sealing layer together with the perforated sheet thus provides respective predetermined breaking points by means of which the degassing openings are closed during normal operation and via which the associated degassing opening is opened by means of the hot gases in the event of the thermal runaway. For this opening, the hot gases at least locally melt the sealing layer, as a result of which the gas can emerge out of the housing interior via the opened-up degassing opening. The sealing layer therefore makes it possible for the battery cells to be particularly readily protected against ingressing water and, furthermore, in the event of the thermal runaway of at least one of the battery cells, reliable conducting away of hot gases via the respective degassing openings of the perforated sheet is made possible.

In a further possible refinement of the invention, provision is made for the sealing layer to have an adhesive layer via which the battery cells are adhesively bonded to the perforated sheet, and/or for the sealing layer to have at least one plastics element which is placed onto the perforated sheet. In other words, an adhesive can be spread on the perforated sheet, the adhesive firstly serving to close the respective degassing openings of the perforated sheet and secondly to adhesively bond the battery cells to the perforated sheet. The adhesive thus makes it possible firstly to seal, in particular watertightly seal, the housing interior and secondly to securely fasten the battery cells in the housing interior. The battery cells can be securely held on the perforated sheet via the adhesive, as a result of which a relative movement of the battery cells to one another or of the battery cells with respect to the battery housing can be prevented, thus keeping a risk of damage to the battery cells particularly low. The plastics element can be, for example, respective plastics stoppers which are inserted into the respective degassing openings of the perforated sheet in order to close the degassing openings. Alternatively, the plastics element can be a plastics panel which is placed onto the perforated sheet, on the side thereof facing the housing interior or on the side thereof facing away from the housing interior, as a result of which at least one degassing opening, in particular a plurality, in particular all of the degassing openings, of the perforated sheet are covered and thus sealed by means of the plastics panel. If just one plastics element is provided, this then seals all of the degassing openings of the perforated sheet. If a plurality of plastics elements are provided to provide the sealing layer, each of these plastics elements then seals at least one degassing opening, in particular a plurality of degassing openings, of the perforated sheet. In the event of a thermal runaway of the associated battery cell, the adhesive layer or the plastics element melts at least in regions as a result of contact with the arising hot gas, thus opening up the associated degassing opening of the perforated sheet. The hot gas can escape via this opened-up degassing opening.

In a further possible refinement of the invention, provision is made for a trough to be arranged on a side of the perforated sheet opposite the battery cells, the trough together with the perforated sheet surrounding a buffer volume in which an impact absorption foam is arranged. The trough, in particular together with the impact absorption foam, can provide an underride guard for the battery or the motor vehicle. The impact absorption foam can be designed specifically for a vehicle and used for different high-voltage stores. Alternatively or additionally, the impact absorption foam can be designed specifically for a store and used for different vehicles. The impact absorption foam is designed to protect the perforated sheet from mechanical damage, such as scratches and consequently from corrosion. The trough can be produced in particular from a metal or a fiber-reinforced plastic. For example, the trough has a sandwich construction consisting of two components stacked one above the other and each consisting of a fiber-reinforced plastic and a spacer, in particular a filling foam, between the components. The impact absorption foam is designed to be deformed in a collision, thus enabling kinetic energy to be converted into deformation energy. By this means, the battery cells of the battery can be particularly readily protected from damage. The trough in turn is designed to hold the impact absorption foam. Furthermore, the trough is designed so as, in the installed position of the battery in the motor vehicle, to prevent impacts from below. The trough and the impact absorption foam therefore make possible a particularly long service life of the battery cells by the latter being particularly readily protected from damage. Furthermore, degassing of the hot gas arising in the event of the thermal runaway of the battery cells is possible into the buffer volume via the degassing openings of the perforated sheet. In this buffer volume, the gas arising in the event of the thermal runaway of the at least one battery cell can be collected and conducted away from the battery cells. For the conducting away of the hot gases from the battery cells, respective conduction channels can be provided in the impact absorption foam.

In this connection, provision may be made in particular for the trough to be tightly connected to the perforated sheet. This means that the buffer volume is tightly surrounded by the perforated sheet, in particular in the presence of the sealing layer, and by the trough. An undesirable flowing of hot gases out of the buffer volume can therefore be avoided.

In a further possible refinement of the invention, provision is made for the trough to be reversibly held on the battery housing. In particular, the trough can be exchanged non-destructively. In particular in the event of damage of the trough, the damaged trough can thus be particularly simply removed from the battery housing and a new trough arranged on and fastened to the battery housing. Complete exchange of the entire battery in the event of damage just to the trough can thus be prevented. The battery is therefore particularly durable and can be particularly easily repaired.

The invention furthermore relates to a motor vehicle, having a battery as has already been described in conjunction with the battery according to the invention.

Further features of the invention may be apparent from the claims, the figures and the description of the figures. The features and combinations of features mentioned above in the description and the features and combinations of features shown below in the description of the figures and/or solely in the figures can be used not only in the respectively stated combination, but also in other combinations or on their own without departing from the scope of the invention.

### BRIEF DESCRIPTION OF THE DRAWINGS

FIG. 1 is a cross section view of a detail of a battery for a motor vehicle;

FIG. 2 shows an enlarged detail of the cross section view of FIG. 1; and

FIG. 3 is a schematic perspective view of a perforated sheet of the battery.

In the figures, identical and functionally identical elements are provided with the same reference signs.

### DETAILED DESCRIPTION OF THE DRAWINGS

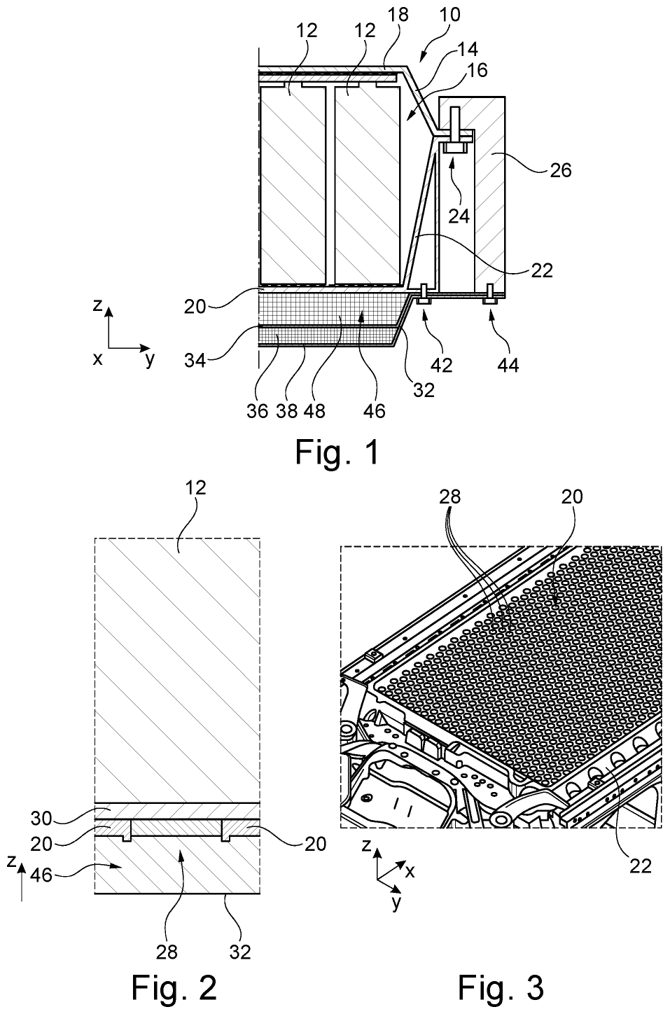

FIG. 1 illustrates, in sectioned form, part of a battery 10 for a motor vehicle. The battery 10 has a multiplicity of battery cells 12 which are designed to provide electrical energy for an electric drive train of the motor vehicle. The battery 10 is in particular a traction battery for the motor vehicle. In addition to the multiplicity of battery cells 12, the battery 10 has a battery housing 14. This battery housing 14 surrounds a housing interior 16, in which the multiplicity of battery cells 12 are accommodated. In the present case, the battery housing 14 has a cover 18 and a perforated sheet 20 which provides a floor of the battery housing 14. In the correct installed position of the battery 10 in the motor vehicle, the cover 18 bounds the housing interior 16 upward in the vertical direction z of the vehicle and the perforated sheet 20 bounds the housing interior 16 downward in the vertical direction z of the vehicle.

As can be seen in FIG. 1, the battery cells 12 are arranged above the perforated sheet 20 in the vertical direction z of the vehicle. In particular, the battery cells 12 are supported by the perforated sheet 20. For this purpose, the battery cells 12 can rest directly or indirectly on the perforated sheet 20. In the present case, the floor of the battery housing 14 is formed by a high-voltage storage trough 22 having the perforated sheet 20. In the present case, this high-voltage storage trough 22 is formed from steel and serves as a shear panel. Both the high-voltage storage trough 22 and the cover 18 are attached here to a sill 26 of the motor vehicle via a first screw connection 24, in the installed position of the battery 10 in the motor vehicle. The high-voltage storage trough 22 with the perforated sheet 20 is shown separately in FIG. 3. As can be seen particularly readily in FIG. 3, the perforated sheet 20 has a multiplicity of degassing openings 28. For clarity reasons, only individual degassing openings of the degassing openings 28 are indicated in FIG. 3 with the associated reference sign. The perforated sheet 20 has an associated degassing opening 28 for each battery cell 12.

FIG. 2 shows a detail of the battery 10, in which it can be particularly readily seen that the respective battery cells 12 are arranged above the respective associated degassing opening 28 in the vertical direction z of the vehicle. In this case, the battery cell 12 completely covers the associated degassing opening 28 in the vertical direction z of the vehicle. The degassing opening 28 is arranged in particular covering a gas discharge opening of the battery cell 12 downward in the vertical direction z of the vehicle. The gas discharge opening of the battery cell 12 is arranged here on an underside of the battery cell 12. Gas flowing out of the associated battery cell 12 via the gas discharge opening, in particular hot gas, in particular as a result of a thermal runaway of this battery cell 12, can therefore be guided away from the relevant battery cell 12 via the associated degassing opening 28. Via the degassing opening 28, the hot gas arising in the battery cell 12 in the event of the thermal runaway can therefore be guided away from the housing interior 16.

In order to ensure that the housing interior 16 is closed watertightly during normal operation of the battery 10 and therefore, in a situation in which there is no thermal runaway of one of the battery cells 12, a sealing layer 30 is provided here. In this case, the sealing layer 30 is arranged between the battery cells 12 and the perforated sheet 20 and is designed to watertightly seal all of the degassing openings 28. The sealing layer 30 can be provided by an adhesive or by a plastics component or by a foam. The sealing layer 30 is designed so as, in the event of a thermal runaway of the battery cell 12, to open up the degassing opening 28 assigned to this battery cell 12. This can be undertaken by the sealing layer 30 locally melting and therefore opening up a passage from the battery cell 12 to the degassing opening 28. Consequently, during normal operation of the battery 10, watertightness of the housing interior 16 can be ensured and it can also be ensured, in the event of the thermal runaway of one of the battery cells 12, that arising hot gases can be conducted away from the housing interior 16 via the associated degassing opening 28.

As can be seen in FIGS. 1 and 2, a trough 32 serving as a bollard guard can be arranged below the battery housing 14 in the vertical direction z of the vehicle. This trough 32 can be an exchangeable floor panel for the battery 10. In the present case, the exchangeable floor panel has a sandwich construction consisting of a first glass fiber-reinforced plastics component 34, a foam 36 and a second glass fiber-reinforced plastics component 38. The trough 32 here is fastened to the high-voltage storage trough 22 via at least one second screw connection 42 and to the sill 26 via at least one third screw connection 44. The at least one second screw connection 42 and the at least one third screw connection 44 permit a non-destructive, reversible exchangeability of the trough 32 on the battery housing 14 of the battery 10 and on the sill 26 of the motor vehicle.

As can be seen particularly readily in FIG. 1 and FIG. 2, the trough 32 together with the perforated sheet 20 bounds a buffer volume 46. An impact absorption foam 48 can be arranged in this buffer volume 46. This impact absorption foam 48 can be adhesively bonded to the perforated sheet 20 on an underside of the perforated sheet 20 facing away from the battery cells 12. By this means, the impact absorption foam 48 is particularly securely fixed in the buffer volume 46. This impact absorption foam 48 is a supporting structure for the battery 10 and serves as a sacrificial component in the event of an impact from below.

The described battery 10 permits an improvement in an overall rigidity of the motor vehicle while simultaneously improving the reparability in the event of minor damage. Furthermore, the battery 10 permits a reduction in weight in comparison to conventional batteries for respective motor vehicles.

In the case of the described battery 10, below the battery cells 12 in the vertical direction z of the vehicle the perforated sheet 20 is provided and, below the perforated sheet 20, the foam, here the impact absorption foam 48, which is integrated in a removable protective component, here the trough 32. In order to prevent the thermal propagation of the battery cells 12 by arising gases being conducted away into the impact absorption foam 48, provision is made for the housing floor to have the perforated sheet 20. Therefore, the battery cells 12 are degassed into the buffer volume 46 which is surrounded by the removable trough 32.

The battery cells 12 can be adhesively bonded to the perforated sheet 20 from above. In this case, the degassing openings 28 are closed watertightly with an adhesive. Alternatively or additionally, the degassing openings 28 are sealed with a plastics component. The perforated sheet 20 can be formed in aluminum or in steel and has a degassing opening 28 under each battery cell 12. The degassing openings 28 are closed in such a manner that degassing of the associated battery cells 12 is possible. This means that hot gas from the battery cell 12 can break through the closure. Below the perforated sheet 20 is arranged the impact absorption foam 48, into which the degassing of the battery cells 12 is possible. The impact absorption foam 48 serves to cushion an action upon the battery 10 from below. This impact absorption foam 48 is preassembled in the trough 32, which is removable from the motor vehicle, and is adhesively bonded to the perforated sheet 20 from below. The trough 32 can be formed from plastic, in particular from glass fiber-reinforced plastic, and/or from light metal.

If the sealing layer 30 is not provided, the housing interior 16 can be downwardly sealed by means of the trough 32 in order to avoid an ingress of water into the housing interior 16.

The sandwich construction of the battery 10 consisting of a housing upper part or the cover 18, the battery cells 12 and the perforated sheet 20 permits a particularly high overall rigidity of the battery 10. A functional separation is therefore produced between the battery housing 14 and the trough 32 which, in combination with the impact absorption foam 48, provides an underride guard. The trough 32 together with the impact absorption foam 48 takes on the functions of propagation protection and underride protection.

Overall, the invention shows how a sandwich high-voltage storage floor with degassing passages, here the degassing openings 28, can be provided for the cell propagation situation.

### LIST OF DESIGNATIONS

10 battery
12 battery cell
14 battery housing
16 housing interior
18 cover
20 perforated sheet
22 housing floor
24 first screw connection
26 sill
28 degassing opening
30 sealing layer
32 trough
34 first glass fiber-reinforced plastics component
36 foam
38 second glass fiber-reinforced plastics component
42 second screw connection
44 third screw connection
46 buffer volume
48 impact absorption foam
z vertical direction of the vehicle
x longitudinal direction of the vehicle
y transverse direction of the vehicle

1. -8. (canceled)

9. A battery for a motor vehicle, comprising:
a multiplicity of battery cells; and
a battery housing that encloses a housing interior, in which the battery cells are accommodated, the battery housing comprising a perforated sheet on which the battery cells are deposited, wherein the perforated sheet has, for each battery cell, an associated degassing opening on which the associated battery cell is deposited and via which gas emerging from the respective associated battery cell is conductable out of the housing interior,
wherein at least one of:
(i) a gap is provided between the battery cells and the perforated sheet, the battery cells in the housing interior are encapsulated in foam and said foam closes the gap and the degassing openings, or
(ii) an impact absorption foam is adhesively bonded onto a side of the perforated sheet opposite the battery cells.

10. The battery according to claim 9, wherein
the battery cells rest directly on the perforated sheet.

11. The battery according to claim 9, wherein
the degassing openings are sealed via a sealing layer which is designed to be broken through by hot gas flowing out of the battery cells in an event of a thermal runaway.

12. The battery according to claim 11, wherein
the sealing layer has an adhesive layer via which the battery cells are adhesively bonded to the perforated sheet, and/or
the sealing layer has at least one plastics element which is placed onto the perforated sheet.

13. The battery according to claim 9, further comprising:
a trough arranged on a side of the perforated sheet opposite the battery cells,
wherein the trough, together with the perforated sheet, surround a buffer volume in which an impact absorption foam is arranged.

14. The battery according to claim 13, wherein
the trough is tightly connected to the perforated sheet.

15. The battery according to claim 13, wherein
the trough is reversibly held on the battery housing.

16. A motor comprising a battery according to claim 9.
